(19) United States
(12) Patent Application Publication
(10) Pub. No.: US 2008/0122988 A1
(43) Pub. Date: May 29, 2008

(54) Multi-Tuner Apparatus for Providing an Emergency Alert Function

(76) Inventor: Gavin Lee Johnston, Overland Park, KS (US)

Correspondence Address: Joseph J. Laks;Thomson Licensing LLC, 2 Independence Way, Patent Operations, PO Box 5312, PRINCETON, NJ, 08543, US

(21) Appl. No.: 11/793,110

(22) PCT Filed: Dec. 13, 2005
(86) PCT No.: PCT/US05/45011

§ 371 Date: Jun. 15, 2007

Related U.S. Application Data
(60) Provisional application No. 60/636,762, filed on Dec. 15, 2004.

(51) Int. Cl. H04N 5/50

(52) U.S. Cl. 348/731; 348/E05.097

(57) ABSTRACT

An apparatus (20) such as a television signal receiver provides an emergency alert function that avoids interrupting a user's program viewing and/or listening activities when the emergency alert function is activated, but still allows the user to be informed regarding emergency events. According to an exemplary embodiment, the apparatus (20) includes a first tuner (22a) operative to tune a first channel including an emergency alert signal. A second tuner (22b) is operative to tune a second channel including at least one of audio and video content. A third tuner (22c) is operative to tune a third channel including at least one of audio and video content responsive to the emergency alert signal.

The present invention generally relates to apparatuses such as television signal receivers and/or other apparatuses having an emergency alert function, and more particularly, to a multi-tuner apparatus for providing an emergency alert function.

Emergency events such as severe weather, natural disasters, fires, civil emergencies, war acts, toxic chemical spills, radiation leaks, or other such conditions can be devastating to unprepared individuals. With weather-related emergencies, authorities such as the National Weather Service (NWS) and the National Oceanographic and Atmospheric Administration (NOAA) are generally able to detect severe weather conditions prior to the general public. Through the use of modern weather detection devices, such as Doppler radar and weather satellites, the NWS and NOAA are able to issue early warnings of severe weather conditions which have saved many lives. However, for such warnings to be effective, they must be communicated to their intended recipients.

Certain apparatuses are capable of receiving emergency alert signals provided by sources such as the NWS and NOAA, and provide an emergency alert function using Specific Area Message Encoding (SAME) technology. Apparatuses using SAME technology typically require a user to perform a setup process for the emergency alert function by selecting items including one or more geographical locations of interest, and one or more types of emergency events which activate the emergency alert function. Once the setup process is complete, the emergency alert function may be activated when incoming emergency alert signals including SAME data indicate the occurrence of an emergency event which corresponds to any of the geographical locations and types of emergency events selected by the user during the setup process. When the emergency alert function is activated, one or more alert outputs such as an audio and/or visual message may be provided to inform individuals of the emergency event.

With conventional apparatuses having an emergency alert function, a problem exists in that users may have their program viewing and/or listening activities interrupted when the emergency alert function is activated. For example, a conventional television signal receiver having an emergency alert function may automatically tune to a specific channel when the emergency alert function is activated, thereby switching away from the user's desired channel and interrupting his/her program viewing and/or listening activities. This can be extremely annoying for users, particularly if the interruption causes the user to miss an important portion of a program (e.g., the final play of a sporting event, climatic scene of a movie, etc.).

Accordingly, there is a need for an apparatus and method for providing an emergency alert function that addresses the foregoing problem, and thereby avoids interrupting a user's program viewing and/or listening activities when the emergency alert function is activated, but still allows the user to be informed regarding emergency events. The present invention addresses these and/or other issues.

In accordance with an aspect of the present invention, an apparatus having an emergency alert function is disclosed. According to an exemplary embodiment, the apparatus comprises first tuning means for tuning a first channel including an emergency alert signal. Second tuning means tunes a second channel including at least one of audio and video content. Third tuning means tunes a third channel including at least one of audio and video content responsive to the emergency alert signal.

In accordance with another aspect of the present invention, a method for controlling an apparatus having an emergency alert function is disclosed. According to an exemplary embodiment, the method comprises steps of using a first tuner to tune a first channel including an emergency alert signal, using a second tuner to tune a second channel including at least one of audio and video content, and using a third tuner to tune a third channel including at least one of audio and video content responsive to the emergency alert signal.

In accordance with another aspect of the present invention, a television signal receiver having an emergency alert function is disclosed. According to an exemplary embodiment, the television signal receiver comprises a first tuner operative to tune a first channel including an emergency alert signal. A second tuner is operative to tune a second channel including at least one of audio and video content. A third tuner is operative to tune a third channel including at least one of audio and video content responsive to the emergency alert signal.

The above-mentioned and other features and advantages of this invention, and the manner of attaining them, will become more apparent and the invention will be better understood by reference to the following description of embodiments of the invention taken in conjunction with the accompanying drawings, wherein:

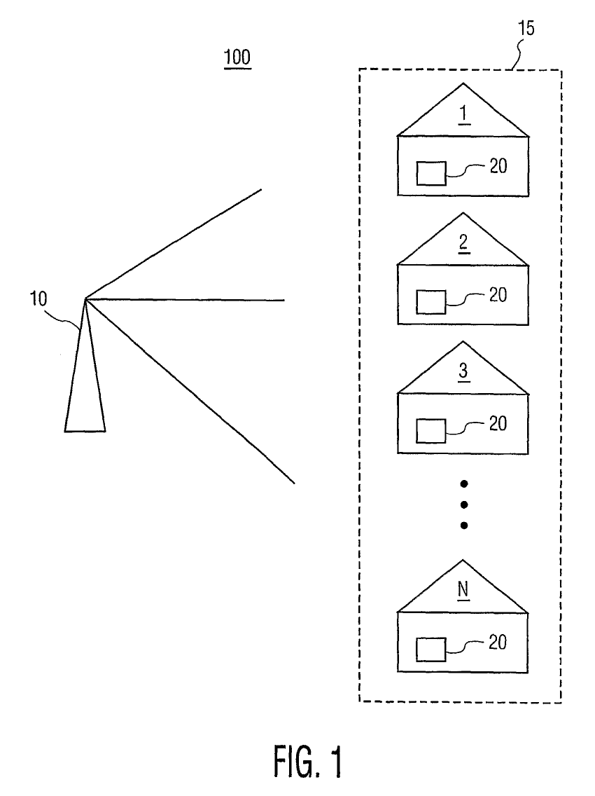

FIG. 1 is an exemplary environment suitable for implementing the present invention;

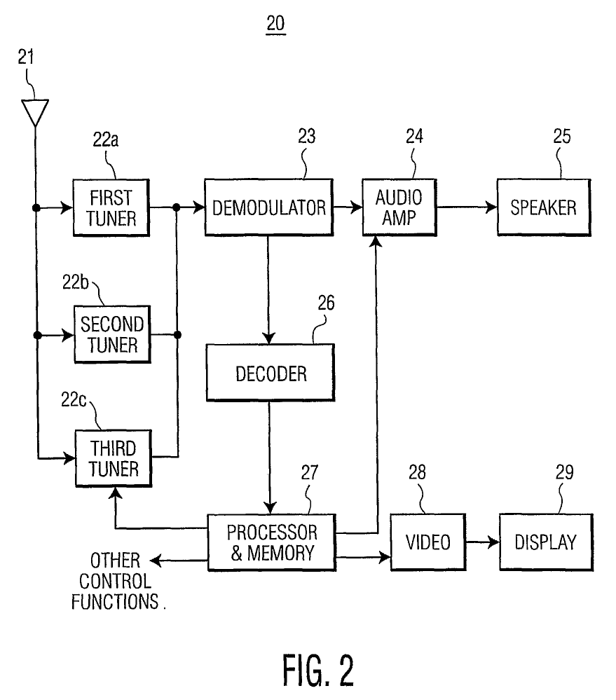

FIG. 2 is a block diagram of an apparatus having an emergency alert function according to an exemplary embodiment of the present invention; and

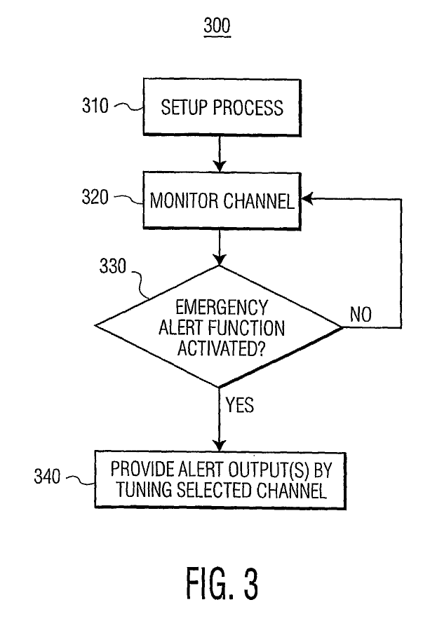

FIG. 3 is a flowchart illustrating steps for providing an emergency alert function according to an exemplary embodiment of the present invention.

The exemplifications set out herein illustrate preferred embodiments of the invention, and such exemplifications are not to be construed as limiting the scope of the invention in any manner.

Referring now to the drawings, and more particularly to FIG. 1, an exemplary environment 100 suitable for implementing the present invention is shown. In FIG. 1, environment 100 comprises signal transmission means such as one or more signal transmitters 10, dwelling means such as dwelling units 15 (i.e., 1, 2, 3 . . . N, where N may be any positive integer), and signal receiving means such as apparatuses 20.

In FIG. 1, dwelling units 15 may represent residences, businesses and/or other dwelling places located within a particular geographical location, such as but not limited to, a particular continent, country, region, state, area code, zip code, city, county, municipality, subdivision, and/or other definable geographical location. According to an exemplary embodiment, each of the dwelling units 15 is equipped with at least one apparatus 20 having an emergency alert function. Apparatus 20 may be embodied as any type of apparatus having an emergency alert function such as a television signal receiver, radio, or other apparatus. According to the present invention, the emergency alert function enables, among other things, apparatus 20 to receive emergency alert signals and provide one or more alert outputs to notify individuals of an emergency event.

According to an exemplary embodiment, signal transmitter(s) 10 transmit signals including audio, video and/or emergency alert signals which may be received by each apparatus 20. Each of the one or more signal transmitters 10 broadcasts such signals to only a limited range of geographical locations. According to an exemplary embodiment, the emergency alert signals may be provided from an authority such as the NWS, or other authorities such as governmental entities or the like. Signal transmitter(s) 10 may transmit the emergency alert signals in their original form as provided by the authority, or may append digital data representative of the emergency alert signals to other data, or may modify the emergency alert signals in some manner appropriate for its specific transmission format needs. In response to the emergency alert signals, each apparatus 20 may provide one or more alert outputs to thereby notify individuals of the emergency event. Signal transmitter(s) 10 may transmit signals to apparatuses 20 via any wired and/or wireless link such as, but not limited to, terrestrial, cable, satellite, fiber optic, digital subscriber line (DSL), and/or any other type of broadcast and/or multicast means.

Referring to FIG. 2, a block diagram of an exemplary embodiment of apparatus 20 of FIG. 1 is shown. In FIG. 2, apparatus 20 comprises signal receiving means such as signal receiving element 21, first to third tuning means such as first to third tuners 22a to 22c, demodulation means such as demodulator 23, audio amplification means such as audio amplifier 24, audio output means such as speaker 25, decoding means such as decoder 26, processing means and memory means such as processor and memory 27, video processing means such as video processor 28, and visual output means such as display 29. Some of the foregoing elements may for example be embodied using integrated circuits (ICs). For clarity of description, certain conventional elements associated with apparatus 20 such as certain control signals, power signals and/or other elements may not be shown in FIG. 2.

Signal receiving element 21 is operative to receive signals including audio, video and/or emergency alert signals from signal sources, such as signal transmitter(s) 10 in FIG. 1. According to an exemplary embodiment, received audio signals may include digitally encoded emergency alert signals. According to another exemplary embodiment, emergency alert signals may be received as separate data packets in a digital transmission system. Signal receiving element 21 may be embodied as any signal receiving element such as an antenna, input terminal or other element.

First to third tuners 22a to 22c are operative to tune channels that provide signals including audio, video and emergency alert signals. According to an exemplary embodiment, first tuner 22a is operative to tune channels that include emergency alert signals. According to this exemplary embodiment, first tuner 22a is capable of tuning channels corresponding to at least the following designated NWS frequencies: 162.400 MHz, 162.425 MHz, 162.450 MHz, 162.475 MHz, 162.500 MHz, 162.525 MHz and 162.550 MHz. The aforementioned channels may provide audio signals that include digitally encoded emergency alert signals. First tuner 22a receives power and operates during all modes of operation, including during an off/standby mode (i.e., apparatus 20 is turned off, but certain elements still receive electrical power), and an on mode (i.e., apparatus 20 is turned on and is capable of providing audio and/or video outputs).

Second tuner 22b is operative to tune channels that include audio and/or video content. According to an exemplary embodiment, second tuner 22b tunes signals including video signals for a main picture of apparatus 20. Third tuner 22c is also operative to tune channels that include audio and/or video content. According to an exemplary embodiment, third tuner 22c tunes signals including video signals for a picture-in-picture (PIP) function of apparatus 20. Second tuner 22b and third tuner 22c each receives power and operates during the on mode of apparatus 20. The channels tuned by second tuner 22b, and third tuner 22c may be selected by user input during the on mode.

As will be described later herein, third tuner 22c automatically tunes to a predetermined channel (e.g., a channel that provides weather-related information, etc.) responsive to first tuner 22a receiving an emergency alert signal that activates the emergency alert function of apparatus 20, while second tuner 22b remains tuned to its current user selected channel. In this manner, the present invention advantageously avoids interrupting a user's program viewing and/or listening activities provided via second tuner 22b when the emergency alert function is activated, but still allows the user to be informed regarding emergency events via information provided via third tuner 22c.

Demodulator 23 is operative to simultaneously demodulate signals provided from first to third tuners 22a to 22c, and may demodulate signals in analog and/or digital transmission formats. According to an exemplary embodiment, demodulator 23 simultaneously demodulates the signals provided from first to third tuners 22a to 22c to thereby generate corresponding demodulated signals. Signals provided from first tuner 22a may for example represent audio content such as an NWS audio message, a warning alert tone and/or other audio content. Audio amplifier 24 is operative to amplify the audio signals output from demodulator 23 responsive to one or more control signals provided from processor 27. Speaker 25 is operative to aurally output the amplified audio signals provided from audio amplifier 24.

Decoder 26 is operative to decode signals including audio, video and/or emergency alert signals. According to an exemplary embodiment, decoder 26 decodes audio signals to thereby extract digitally encoded frequency shift keyed (FSK) signals, which represent emergency alert signals indicating an emergency event. Decoder 26 may also perform other decoding functions, such as decoding data which represents emergency alert signals included in the vertical blanking interval (VBI) of an analog television signal.

According to an exemplary embodiment, the emergency alert signals include data comprising SAME data associated with the emergency event. SAME data comprises a digital code representing information such as the specific geographical location affected by the emergency event, the type of emergency event (e.g., tornado watch, radiological hazard warning, civil emergency, etc.), and the expiration time of the event alert. SAME data is used by the NWS and other authorities to improve the specificity of emergency alerts and to decrease the frequency of false alerts. Other data and information may also be included in the emergency alert signals according to the present invention.

Processor and memory 27 are operative to perform various processing and data storage functions of apparatus 20. According to an exemplary embodiment, processor 27 receives the emergency alert-signals from decoder 26 and determines whether the emergency alert function of apparatus 20 is activated based on data included in the emergency alert signals. According to this exemplary embodiment, processor 27 compares data in the emergency alert signals to user setup data stored in memory 27 to determine whether the emergency alert function is activated. As will be described later herein, a setup process for the emergency alert function of apparatus 20 allows a user to select items such as an applicable geographical location(s), and type(s) of emergency events (e.g., tornado watch, radiological hazard warning, civil emergency, etc.) which activate the emergency alert function.

When the emergency alert function of apparatus 20 is activated, processor 27 outputs one or more control signals which enable various operations including one or more alert outputs (e.g., aural and/or visual) to thereby notify individuals of the emergency event. Such control signals may also enable other operations of apparatus 20, such as causing it to be switched from the off/standby mode to the on mode. According to an exemplary embodiment, processor 27 outputs a control signal when the emergency alert function of apparatus 20 is activated that causes third tuner 22c to tune to a predetermined channel (e.g., a channel that provides weather-related information, etc.). Video content from this predetermined channel may then be provided as a PIP overlay upon video content of the main picture provided via second tuner 22b. In this manner, if a user is currently viewing a desired channel as the main picture when the emergency alert function of apparatus 20 is activated, this viewing activity is not completely interrupted, and the user is concurrently informed regarding the emergency event via the PIP overlay provided via third tuner 22c. As indicated in FIG. 2, processor 27 also provides control signals for other control functions of apparatus 20 such as controlling the channel tuning functions of first and second tuners 22a and 22b responsive to user inputs. Memory 27 is operative to store data including user setup data and on-screen menu data for the emergency alert function.

Video processor 28 is operative to process signals including video signals. According to an exemplary embodiment, such video signals may include embedded messages such as NWS text messages and/or other messages that provide details regarding emergency events. Video processor 28 may include closed caption circuitry which enables closed caption displays.

Display 29 is operative to provide visual displays. According to an exemplary embodiment, display 29 may provide visual displays including the aforementioned messages that provide details regarding emergency events. Display 29 may also include a viewable display panel having one or more indicator elements such as light emitting diodes (LEDs), liquid crystal display (LCD) elements, liquid quartz display (LQD) elements, and/or other elements. Such indicator elements may include highlighted indicators, such as monochrome and/or colored indicators, plasma display indicators, and/or conventional lights used as consumer electronic product indicators, and may for example reside apart from apparatus 20, such as on a portable (e.g., non-tethered) lighted panel designed for a wall and/or desk display.

Turning now to FIG. 3, a flowchart 300 illustrating exemplary steps for providing an emergency alert function is shown. For purposes of example and explanation, the steps of FIG. 3 will be described with reference to apparatus 20 of FIG. 2. The steps of FIG. 3 are merely exemplary, and are not intended to limit the present invention in any manner.

At step 310, a setup process for the emergency alert function of apparatus 20 is performed. According to an exemplary embodiment, a user performs this setup process by providing inputs to apparatus 20 (e.g., using a remote control device not shown in FIGS.) responsive to on-screen menus displayed via display 29. According to an exemplary embodiment, the user may select at least the following items during the setup process at step 310:

### A. Enable/Disable—The user may select whether to enable or disable the emergency alert function.

B. Monitoring Channel(s)—The user may select one or more channels that are monitored by first tuner 22a in order to receive emergency alert signals. For example, the user may select channels corresponding to one or more of the following NWS transmission frequencies: 162.400 MHz, 162.425 MHz, 162.450 MHz, 162.475 MHz, 162.500 MHz, 162.525 MHz and 162.550 MHz. Channels may be manually selected by the user, or may be automatically selected by apparatus 20.
C. Geographical Locations—The user may select one or more geographical locations of interest. For example, the user may select a particular continent, country, region, state, area code, zip code, city, county, municipality, subdivision, and/or other definable geographical location. According to an exemplary embodiment, such geographical location(s) may be represented by location codes, such as Federal Information Processing Standard (FIPS) location codes.
D. Event Types—The user may select one or more types of emergency events which activate the emergency alert function. For example, the user may designate that events such as civil emergencies, radiological hazard warnings, and/or tornado warnings activate the emergency alert function, but that events such as a thunderstorm watch do not, etc. The user may also select whether the conventional warning audio tone provided by the NWS and/or other alert mechanism activates the emergency alert function. According to the present invention, different severity or alert levels (e.g., advisory level, watch level, warning level, etc.) may distinguish different events. For example, a thunderstorm watch may be considered a different event from a thunderstorm warning.
E. Alert Outputs—The user may select one or more alert outputs to be provided when the emergency alert function is activated. According to an exemplary embodiment, the user may select visual and/or aural outputs to be provided for each type of emergency event that activates the emergency alert function. For example, the user may select to display a visual message (e.g., an NWS text message as a closed caption display) and/or to tune apparatus 20 to a predetermined channel (e.g., a channel that provides weather-related information, etc.) selected by the user. According to an exemplary embodiment, this predetermined channel is tuned via third tuner 22c when the emergency alert function is activated and provided as a PIP overlay upon a main picture tuned via second tuner 22b. The user may also for example select to aurally output a warning tone (e.g., chime, siren, etc.) and/or an audio message (e.g., NWS audio message). Other types of alert outputs may also be provided according to the present invention.

According to the present invention, other menu selections may also be provided at step 310 and/or some of the menu selections described above may be omitted. Data corresponding to the user's selections during the setup process of step 310 is stored in memory 27.

At step 320, apparatus 20 monitors the channel(s) selected by the user during the setup process of step 310 (i.e., item B) for emergency alert signals. According to an exemplary embodiment, first tuner 22a monitors the selected channel(s) to thereby receive emergency alert signals. As previously indicated herein, first tuner 22a is capable of monitoring channels and receiving emergency alert signals during all modes of operation, including the previously described off/standby and on modes.

At step 330, a determination is made as to whether the emergency alert function of apparatus 20 is activated. According to an exemplary embodiment, processor 27 makes this determination by comparing data included in the incoming emergency alert signals to data stored in memory 27. As previously indicated herein, the emergency alert signals may include data such as SAME data which represents information including the specific geographical location(s) affected by the emergency event, and the type of emergency event (e.g., tornado watch, radiological hazard warning, civil emergency, etc.). According to an exemplary embodiment, processor 27 compares this SAME data to corresponding user setup data (i.e., items C and D of step 310) stored in memory 27 to thereby determine whether the emergency alert function is activated. In this manner, the emergency alert function of apparatus 20 is activated when the emergency event indicated by the emergency alert signals corresponds to: (1) any geographical location(s) selected by the user under item C of step 310 and (2) any event type(s) selected by the user under item D of step 310.

If the determination at step 330 is negative, process flow loops back to step 320 where first tuner 22a continues to monitor the selected channel(s) for emergency alert signals. Alternatively, if the determination at step 330 is positive, process flow advances to step 340 where apparatus 20 provides one or more alert outputs to thereby notify individuals of the emergency event.

According to an exemplary embodiment, processor 27 enables the one or more alert outputs at step 340 in accordance with the user's selections during the setup process of step 310 (i.e., item E), and such alert outputs may be aural and/or visual in nature. Also, if apparatus 20 is in the off/standby mode when the emergency alert function is activated, processor 27 may first output one or more control signals which cause apparatus 20 to switch to the on mode.

To enable visual alert outputs at step 340, processor 27 outputs a control signal that causes third tuner 22c to tune to a predetermined channel (e.g., a channel that provides weather-related information, etc.) selected during the setup process of step 310 (i.e., item E). Video content from this predetermined channel is then provided on display 29 as a PIP overlay upon video content of the main picture provided via second tuner 22b. The position and size of the PIP provided at step 340 is a matter of design choice, but it is preferably positioned and sized so as to avoid interfering with user viewing of the main picture to the extent reasonably possible. If third tuner 22c is tuning a channel other than the predetermined channel when the emergency alert function is activated, the control signal output from processor 27 causes third tuner 22c to automatically switch to the predetermined channel. In this manner, if a user is currently viewing a desired channel as the main picture when the emergency alert function is activated, this viewing activity is not completely interrupted, and the user is concurrently informed regarding the emergency event via the PIP overlay provided via third tuner 22c. Aural outputs such as a warning tone and/or an NWS audio message may also be provided at step 340 via speaker 25. Other types of aural and/or visual alert outputs than those expressly described herein may also be provided according to the present invention.

As described herein, the present invention provides an apparatus and method for providing an emergency alert function that, among other things, avoids interrupting a user's program viewing and/or listening activities when the emergency alert function is activated, but still allows the user to be informed regarding emergency events. The present invention may be applicable to various apparatuses, either with or without an integrated display device. Accordingly, the phrase “television signal receiver” as used herein may refer to systems or apparatuses including, but not limited to, television sets, computers or monitors that include an integrated display device, and systems or apparatuses such as set-top boxes, video cassette recorders (VCRs), digital versatile disk (DVD) players, video game boxes, personal video recorders (PVRs), computers or other apparatuses that may not include an integrated display device.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1. An apparatus (20) having an emergency alert function, comprising:
first tuning means (22a) for tuning a first channel including an emergency alert signal;
second tuning means (22b) for tuning a second channel including at least one of audio and video content; and
third tuning means (22c) for tuning a third channel including at least one of audio and video content responsive to said emergency alert signal.

2. The apparatus (20) of claim 1, further comprising processing means (27) for enabling said third tuning means (22c) to tune said third channel if said emergency alert signal indicates an emergency event corresponding to a user selected geographical location.

3. The apparatus (20) of claim 1, further comprising processing means (27) for enabling said third tuning means (22c) to tune said third channel if said emergency alert signal indicates an emergency event corresponding to a user selected event type.

4. The apparatus (20) of claim 1, wherein:
said second channel includes first video content;
said third channel includes second video content; and
said second video content is overlaid upon said first video content.

5. The apparatus (20) of claim 1, wherein said third tuning means (22c) tunes a fourth channel including at least one of audio and video content prior to said apparatus (20) receiving said emergency alert signal, and switches from said fourth channel to said third channel responsive to said emergency alert signal.

6. The apparatus (20) of claim 5, wherein said third channel provides weather information.

7. A method (300) for controlling an apparatus having an emergency alert function, comprising steps of:
using a first tuner (22a) to tune a first channel including an emergency alert signal;
using a second tuner (22b) to tune a second channel including at least one of audio and video content; and
using a third tuner (22c) to tune a third channel including at least one of audio and video content responsive to said emergency alert signal.

8. The method (300) of claim 7, further comprised of enabling said third tuner (22c) to tune said third channel if said emergency alert signal indicates an emergency event corresponding to a user selected geographical location.

9. The method (300) of claim 7, further comprised of enabling said third tuner (22c) to tune said third channel if said emergency alert signal indicates an emergency event corresponding to a user selected event type.

10. The method (300) of claim 7, wherein:
said second channel includes first video content;
said third channel includes second video content; and
said second video content is overlaid upon said first video content.

11. The method (300) of claim 7, wherein said third tuner (22c) tunes a fourth channel including at least one of audio and video content prior to said apparatus receiving said emergency alert signal, and switches from said fourth channel to said third channel responsive to said emergency alert signal.

12. The method (300) of claim 11, wherein said third channel provides weather information.

13. A television signal receiver (20) having an emergency alert function, comprising:
a first tuner (22a) operative to tune a first channel including an emergency alert signal;
a second tuner (22b) operative to tune a second channel including at least one of audio and video content; and
a third tuner (22c) operative to tune a third channel including at least one of audio and video content responsive to said emergency alert signal.

14. The television signal receiver (20) of claim 13, further comprising a processor (27) operative to enable said third tuner (22c) to tune said third channel if said emergency alert signal indicates an emergency event corresponding to a user selected geographical location.

15. The television signal receiver (20) of claim 13, further comprising a processor (27) operative to enable said third tuner (22c) to tune said third channel if said emergency alert signal indicates an emergency event corresponding to a user selected event type.

16. The television signal receiver (20) of claim 13, wherein:
said second channel includes first video content;
said third channel includes second video content; and
said second video content is overlaid upon said first video content.

17. The television signal receiver (20) of claim 13, wherein said third tuner (22c) tunes a fourth channel including at least one of audio and video content prior to said television signal receiver (20) receiving said emergency alert signal, and switches from said fourth channel to said third channel responsive to said emergency alert signal.

18. The television signal receiver (20) of claim 17, wherein said third channel provides weather information.
